(19) United States
(12) Patent Application Publication
(10) Pub. No.: US 2021/0224901 A1
(43) Pub. Date: Jul. 22, 2021

(54) SYSTEM AND METHOD FOR CREDIT ASSESSMENT

(71) Applicant: SUANHUA INTELLIGENT TECHNOLOGY CO., LTD., Shanghai (CN)

(72) Inventor: Qingjun JIANG, Shanghai (CN)

(73) Assignee: SUANHUA INTELLIGENT TECHNOLOGY CO., LTD., Shanghai (CN)

(21) Appl. No.: 17/223,071

(22) Filed: Apr. 6, 2021

Related U.S. Application Data
(63) Continuation of application No. PCT/CN2019/075413, filed on Feb. 19, 2019.

(51) Int. Cl. G06Q 40/02; G06Q 50/00; G06N 20/00; G06N 5/04

(52) U.S. Cl. CPC G06Q 40/025; G06N 5/04; G06N 20/00; G06Q 50/01

(57) ABSTRACT

A method for credit assessment is provided. The method may include receiving a request to determine a credit assessment score of a target entity from a terminal device. The method may also include acquiring credit assessment information related to the target entity. The credit assessment information may at least include one or more credit grades with respect to the target entity assessed by one or more assessors. The method may also include determining a weight factor of each of the one or more assessors, and determining a credit assessment score of the target entity using a trained credit assessment model. At least the credit assessment information and the weight factor of each of the one or more assessors may be an input of the trained credit assessment model. The method may further include transmitting the credit assessment score of the target entity to the terminal device for display.

### CROSS-REFERENCE TO RELATED APPLICATIONS

This application is a continuation of International Patent Application No. PCT/CN2019/075413, filed on Feb. 19, 2019, the contents of which are hereby incorporated by reference.

### TECHNICAL FIELD

The present disclosure generally relates to credit assessment, and more particularly, to systems and methods for determining a credit assessment score of a target entity based on credit assessment information related to the target entity assessed by others.

### BACKGROUND

The credit of an entity (e.g., a person, an institution) often needs to be assessed in various cases. For example, the bank may determine whether to approve a loan to a borrower by assessing the borrower's credit. Normally, the credit assessment may be performed based on an analysis of a certain behavior (e.g., not paying debt) and/or profile information (e.g., income, occupation) of the entity, which may fail to provide a comprehensive and reliable assessment result. Therefore, it is desirable to provide more effective and reliable systems and methods for credit assessment.

### SUMMARY

In one aspect of the present disclosure, a system is provided. The system may include a data communication port communicatively connected to a network, at least one storage medium storing a set of instructions for credit assessment, and at least one processor configured to communicate with the at least one storage medium and the data communication port. When executing the set of instructions, the at least one processor is configured to direct the system to receive a request to determine a credit assessment score of a target entity from a terminal device via the data communication port. The at least one processor may be also configured to direct the system to acquire credit assessment information related to the target entity. The credit assessment information may at least include one or more credit grades with respect to the target entity assessed by one or more assessors. The at least one processor may be further configured to direct the system to determine a weight factor of each of the one or more assessors, and determine a credit assessment score of the target entity using a trained credit assessment model. At least the credit assessment information and the weight factor of each of the one or more assessors may be an input of the trained credit assessment model. The at least one processor may be further configured to direct the system to transmit the credit assessment score of the target entity to the terminal device for display via the data communication port.

In some embodiments, at least one credit grade of the one or more credit grades of the target entity may be acquired from a third party platform. The third party platform may include at least one of a bank platform, a loan platform, a credit bureau platform, a lending platform, a social network platform, a renting platform, a transaction platform, or an online to offline service platform.

In some embodiments, to acquire the at least one credit grade from a third party platform, the at least one processor may be further configured to direct the system to acquire a credit comment corresponding to the at least one credit grade with respect to the target entity from the third party platform via the data communication port. The at least one processor may be further configured to direct the system to determine the at least one credit grade based on the credit comment.

In some embodiments, at least one credit grade of the one or more credit grades of the target entity may be acquired by a credit grade collection process. The credit grade collection process may include transmitting one or more credit assessment questions to the corresponding assessor. At least one of the credit assessment questions may be about the credit grade of the target entity. The credit grade collection process may also include receiving a response from the corresponding assessor. The credit grade collection process may further include determining the at least one credit grade based on the response from the corresponding assessor.

In some embodiments, the credit assessment information related to the target entity may further include at least one of time information related to each credit grade, a source from which each credit grade is acquired, a relationship between the target entity and each assessor, or a scenario in which each credit grade was assessed by the corresponding assessor, or credit information of each assessor.

In some embodiments, the target entity and the one or more assessors may be registered users of a credit assessment system.

In some embodiments, to determine the weight factor of each of the one or more assessors, the at least one processor may be further configured to direct the system to determine the weight factors of the one or more assessors at least based on one or more reference credit assessment scores of the one or more assessors.

In some embodiments, to determine the weight factor of each of the one or more assessors, the at least one processor may be further configured to direct the system to acquire the one or more weight factors of the one or more assessors. The at least one processor may be also directed to acquire a new reference credit assessment score of at least one of the assessors. The at least one processor may be further directed to update the weight factors of the one or more assessors based on the new reference credit assessment score of the at least one of the assessors.

In some embodiments, the trained credit assessment model may be trained according to a model training process. The model training process may include obtaining sample credit assessment information related to a plurality of sample entities. The sample credit assessment information related to each sample entity may at least include one or more sample credit grades with respect to the sample entities assessed by one or more sample assessors. The model training process may also include obtaining reference credit assessment scores of at least some of the plurality of sample entities and an initial model. The initial model may have one or more model parameters. The model training process may further include generating the trained credit assessment model by iteratively updating values of the one or more model parameters of the initial model based on the sample credit assessment information and the reference credit assessment scores of the at least some of the plurality of sample entities.

In some embodiments, the trained credit assessment model may be at least one of a random forest model, an XGboost model, a decision tree model, or a logistic regression model.

In another aspect of the present disclosure, a system is provided. The system may include a data communication port communicatively connected to a network, at least one storage medium storing a set of instructions for generating a trained credit assessment model and at least one processor configured to communicate with the at least one storage medium and the data communication port. When executing the set of instructions, the at least one processor may be configured to direct the system to obtain sample assessment information related to a plurality of sample entities. The sample credit assessment information related to each sample entity at least may include one or more sample credit grades with respect to the sample entities assessed by one or more sample assessors. The at least one processor may be also configured to direct the system to obtain reference credit assessment scores of at least some of the sample entities and an initial model. The initial model may have one or more model parameters. The at least one processor may be further configured to direct the system to generate the trained credit assessment model by iteratively updating values of the one or more model parameters of the initial model based on the sample credit assessment information and the reference credit assessment scores of the at least some of the plurality of sample entities.

In some embodiments, the trained credit assessment model may be at least one of a random forest model, an XGboost model, a decision tree model, or a logistic regression model.

In another aspect of the present disclosure, a terminal device is provided. The terminal device may include a data communication port communicatively connected to a network, an I/O component, at least one storage medium storing a set of instructions and at least one processor. The at least one processor may be configured to communicate with the at least one storage medium and the data communication port, wherein when executing the set of instructions, the at least one processor may be configured to direct the terminal device to receive a request to determine a credit assessment score of a target entity from a user via the I/O component. The at least one processor may also be configured to direct the terminal device to transmit the request to a credit assessment system via the data communication port. The at least one processor may also be configured to direct the terminal device to receive the credit assessment score of the target entity from the credit assessment system via the data communication port. The at least one processor may also be configured to direct the terminal device to display the credit assessment score of the target entity via the I/O component. The credit assessment score of the target entity may at least be based on credit assessment information related to the target entity and a weight factor of each of the one or more assessors. The credit assessment information may at least include one or more credit grades with respect to the target entity assessed by one or more assessors.

In some embodiments, the credit assessment score may be further based on a trained credit assessment model. The credit assessment information and the weight factor of each of the one or more assessors may be an input of the trained credit assessment model.

In some embodiments, the credit assessment information related to the target entity may further include at least one of time information related to the one or more credit grades, a source from which each credit grade is acquired, a relationship between the target entity and each assessor, or a scenario in which each credit grade was assessed by the corresponding assessor, or credit information of each assessor.

In some embodiments, the weight factor of each of the one or more assessors may at least be based on one or more reference credit assessment scores of the one or more assessors.

In another aspect of the present disclosure, a method is provided. The method may be implemented on a computing device having at least one processor, at least one computer-readable storage medium, and a data communication port connected to a network. The method may include receiving a request to determine a credit assessment score of a target entity from a terminal device via the data communication port. The method may also include acquiring credit assessment information related to the target entity. The credit assessment information may at least include one or more credit grades with respect to the target entity assessed by one or more assessors. The method may also include determining a weight factor of each of the one or more assessors, and determining a credit assessment score of the target entity using a trained credit assessment model. At least the credit assessment information and the weight factor of each of the one or more assessors may be an input of the trained credit assessment model. The method may further include transmitting the credit assessment score of the target entity to the terminal device for display via the data communication port.

In another aspect of the present disclosure, a method is provided. The method may be implemented on a computing device having at least one processor and at least one computer-readable storage medium. The method may include obtaining sample credit assessment information related to a plurality of sample entities. The sample credit assessment information related to each sample entity may at least include one or more sample credit grades with respect to the sample entities assessed by one or more sample assessors. The method may also include obtaining reference credit assessment scores of at least some of the plurality of sample entities and an initial model. The initial model may have one or more model parameters. The method may further include generating the trained credit assessment model by iteratively updating values of the one or more model parameters of the initial model based on the sample credit assessment information and the reference credit assessment scores of the at least some of the plurality of sample entities.

In another aspect of the present disclosure, a method is provided. The method may be implemented on a computing device having at least one processor, at least one computer-readable storage medium and a data communication port. The method may include receiving a request to determine a credit assessment score of a target entity from a user. The method may also include transmitting the request to a credit assessment system via the data communication port. The method may also include receiving the credit assessment score of the target entity from the credit assessment system via the data communication port. The method may further include displaying the credit assessment score of the target entity. The credit assessment score of the target entity may be at least based on credit assessment information related to the target entity and a weight factor of each of the one or more assessors. The credit assessment information may at least include one or more credit grades with respect to the target entity assessed by one or more assessors.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagrams illustrating an credit assessment system according to some embodiments of the present disclosure;

FIG. 2 is a schematic diagram illustrating exemplary hardware and/or software components of an exemplary computing device according to some embodiments of the present disclosure;

FIG. 3 is a schematic diagram illustrating exemplary hardware and/or software components of an exemplary mobile device according to some embodiments of the present disclosure;

FIG. 4 is a block diagram illustrating an exemplary processing engine according to some embodiments of the present disclosure;

FIG. 5 is a flowchart illustrating an exemplary process for credit assessment according to some embodiments of the present disclosure;

FIG. 6 is a flowchart illustrating an exemplary process for determining a credit grade with respect to a target entity according to some embodiments of the present disclosure;

FIG. 7 is a flowchart illustrating an exemplary process for generating a trained credit assessment model according to some embodiments of the present disclosure; and

FIG. 8 is a flowchart illustrating an exemplary process for credit assessment according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “engine,” “unit,” “module,” and/or “block” used herein are one method to distinguish different components, elements, parts, section or assembly of different level in ascending order. However, the terms may be displaced by other expression if they achieve the same purpose.

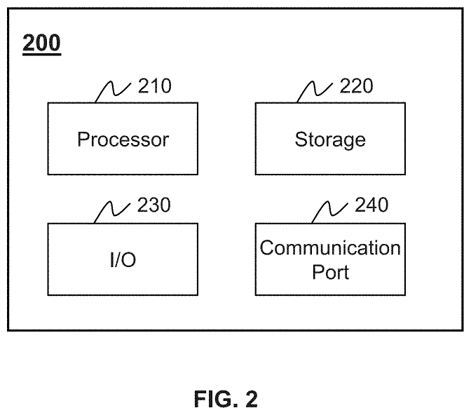

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or other storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices (e.g., processor 210 as illustrated in FIG. 2) may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in a firmware, such as an EPROM. It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may be applicable to a system, an engine, or a portion thereof.

It will be understood that when a unit, engine, module or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The present disclosure relates to systems and methods for determining a credit assessment score of a target entity. To this end, the systems and methods may acquire credit assessment information of the target entity. The credit assessment information may at least include one or more credit grades with respect to the target entity assessed by one or more assessors. The credit assessment information may be acquired from various sources, such as a bank platform, a loan platform, a credit bureau platform, a lending platform, a social network platform, or the like, or any combination thereof. The systems and methods may further determine a weight factor of each of the assessor(s). The weight factor of an assessor may be associated with the credibility of the assessor and indicate an impact of the credit grade assessed by the assessor on the credit assessment score of the target entity. The systems and methods may further determine the credit assessment score of the target entity using a trained credit assessment model, wherein at least the credit assessment information of the target entity and the weight factor of each of the one or more assessors are an input of the trained credit assessment model.

Compared with conventional credit assessment techniques, the credit assessment score of the target entity in the present disclosure is determined based on the credit assessment information of the target entity acquired from various sources. The credit grade(s) with respect to the target entity assessed by one or more assessors and/or other factors, such as the weight factors of the one or more assessors are considered in the determination of the credit assessment score. Moreover, a machine learning method is unitized to provide a reliable result of the credit assessment score based on the credit assessment information. Therefore, the systems and methods disclosed in the present disclosure may provide a more comprehensive and reliable credit assessment result of the target entity.

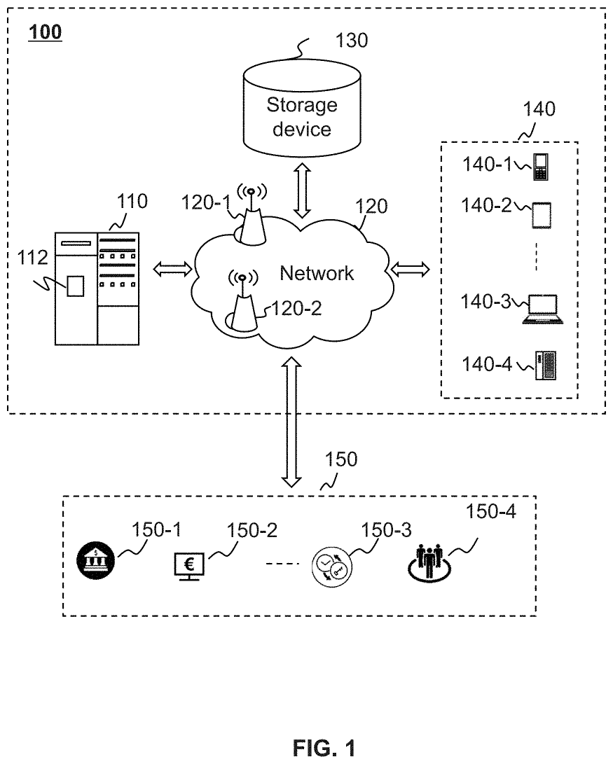

FIG. 1 is a schematic diagram of an exemplary credit assessment system 100 according to some embodiments of the present disclosure. The credit assessment system 100 may be configured to assess a credit of an entity. The credit of the entity may indicate the degree of trustworthiness and reliability of the entity. The entity may include, for example, an individual, a legal person, an organization, or any other type of concrete or abstract entity. As shown in FIG. 1, the credit assessment system 100 may include a server 110, a network 120, a storage device 130, and a terminal device 140. The credit assessment system 100 may be connected to and/or communicated with one or more third party platforms 150.

In some embodiments, the server 110 may be a single server, or a server group. The server group may be centralized, or distributed (e.g., server 110 may be a distributed system). In some embodiments, the server 110 may be local or remote. For example, the server 110 may access information and/or data stored in the storage device 130 via the network 120. As another example, the server 110 may connect to the storage device 130 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may be configured to process information and/or data relating to the credit assessment system 100 to perform one or more functions described in the present disclosure. For example, the processing engine 112 may determine a credit assessment score of a target entity according to credit assessment information related to the target entity.

In some embodiments, the processing engine 112 may include one or more processing engines (e.g., single-core processing engine(s) or multi-core processor(s)). Merely by way of example, the processing engine 112 may include one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the credit assessment system 100 (e.g., the server 110, the terminal device 140, and the storage device 130) may transmit information and/or data to other component(s) in the credit assessment system 100 via the network 120. For example, the terminal device 140 may send a request to the server 110 via the network 120 to determine a credit assessment score of a target entity. As another example, the server 110 may obtain credit assessment information related to the target entity from a third party platform 150 via the network 120. In some embodiments, the network 120 may be any type of wired or wireless network, or combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2 . . . through which one or more components of the credit assessment system 100 may be connected to the network 120 to exchange data and/or information between them.

The storage device 130 may store data and/or instructions. For example, the storage device 130 may store credit assessment information related one or more entities. As still an example, the storage device 130 may store data and/or instructions that the server 110 may execute or use to perform exemplary methods described in the present disclosure. In some embodiments, the storage device 130 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random-access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM. etc. In some embodiments, the storage device 130 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 130 may include at least one network port to communicate with other devices in the credit assessment system 100. For example, the storage device 130 may be connected to the network 120 to communicate with one or more components of the credit assessment system 100 (e.g., the server 110, the terminal device 140) via the at least one network port. One or more components in the credit assessment system 100 may access the data or instructions stored in the storage device 130 via the network 120. In some embodiments, the storage device 130 may be directly connected to or communicate with one or more components in the credit assessment system 100 (e.g., the server 110, the terminal device 140). In some embodiments, the storage device 130 may be part of the server 110.

The terminal device 140 may be used by a user to interact with one or more other components of the credit assessment system 100. For example, the user may transmit a request to assess a credit assessment score of a target entity to the processing engine 112 via the terminal device 140. Additionally or alternatively, the user may view the credit assessment score of the target entity on the terminal device 140. In some embodiments, the user may acquire and/or view the credit assessment score of the target entity only if the target entity permits to do so. In some embodiments, the user of the terminal device 140 may be any organization or individual.

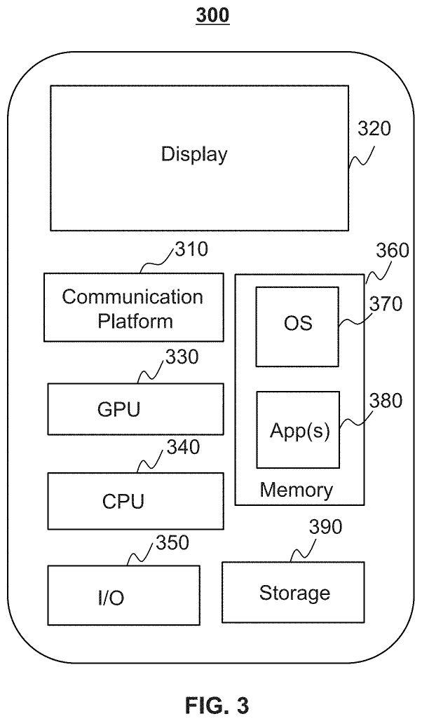

In some embodiments, the terminal device 140 may include any type of devices, for example, a mobile device, an electronic device, an automobile, or the like, or any combination thereof. For example, the terminal device 140 may include a mobile device 140-1, a laptop computer 140-2, a desktop computer 140-3, a built-in device in a motor vehicle 140-4, or the Ike, or any combination thereof. The built-in device 140-4 may include an onboard computer, an onboard television, an onboard positioning system, etc. The mobile device 140-1 may include a wearable device, a smart mobile device, a virtual reality device, an augmented reality device, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistant (PDA), a gaming device, a navigation device, a point of sale (POS) device, or the Ike, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass™, a RiftCon™, a Fragments™, a Gear VR™, etc. In some embodiments, the terminal device 140 may be a device with positioning technology for locating the position of the terminal device 140 and/or the user thereof. In some embodiments, the terminal device 140 may be implemented on a computing device 200 having one or more components illustrated in FIG. 2, or a mobile device 300 having one or more components illustrated in FIG. 3 in the present disclosure.

The third party platform(s) 150 may be any platform that may include credit assessment information related to one or more entities. The credit assessment information included in a third party platform 150 may include, for example, a credit assessment (or comment) regarding an entity, profile information and/or finical information of the entity, or the like, or any combination thereof. The credit assessment (or comment) regarding an entity may be determined by the third party platform 150 and/or by another entity on the third party platform 150. Exemplary third party platforms 150 may include a bank platform 150-1, a transaction platform 150-2, a lending platform 150-3, a social network platform 150-4, a renting platform, a loan platform, a credit bureau platform, an online to offline service platform (e.g., a meal booking service platform, a transportation service platform, a delivery service platform), or the like. In some embodiments, the processing engine 112 may acquire credit assessment information related to a target entity from one or more third party platforms 150 via the network 120. The processing engine 112 may then determine a credit assessment score of the target entity based at least in part on the credit assessment information acquired from the third party platform(s) 150. In some embodiments, a user may appeal or send a request to verify the credit assessment information related to the user acquired from the third party platforms 150 if he/she doubts the credit assessment information.

FIG. 2 is a schematic diagram illustrating exemplary hardware and software components of a computing device 200 according to some embodiments of the present disclosure. The computing device 200 may be used to implement any component of the credit assessment system 100 to perform one or more functions disclosed in the present disclosure. For example, the processing engine 112 may be implemented on the computing device 200, via its hardware, software program, firmware, or a combination thereof. For brevity, FIG. 2 depicts only one computing device. The functions of the computing device 200 relating to the credit assessment as described herein may be implemented in a distributed fashion on a number of similar platforms, to distribute the processing load.

The processor 210 may execute computer instructions (e.g., program code) and perform functions of the processing engine 112 in accordance with techniques described herein. The computer instructions may include, for example, routines, programs, objects, components, data structures, procedures, modules, and functions, which perform particular functions described herein. In some embodiments, the processor 210 may include one or more hardware processors, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof.

Merely for illustration, only one processor is described in the computing device 200. However, it should be noted that the computing device 200 in the present disclosure may also include multiple processors, thus operations and/or method steps that are performed by one processor as described in the present disclosure may also be jointly or separately performed by the multiple processors. For example, if in the present disclosure the processor of the computing device 200 executes both step A and step B, it should be understood that step A and step B may also be performed by two or more different processors jointly or separately in the computing device 200 (e.g., a first processor executes step A and a second processor executes step B, or the first and second processors jointly execute steps A and B).

The storage 220 may store data/information obtained from the server 110, the storage device 130, the terminal device 140, the third party platform 150, and/or any other component of the credit assessment system 100. In some embodiments, the storage 220 may include a mass storage, a removable storage, a volatile read-and-write memory, a read-only memory (ROM), or the like, or any combination thereof. For example, the mass storage may include a magnetic disk, an optical disk, a solid-state drives, etc. The removable storage may include a flash drive, a floppy disk, an optical disk, a memory card, a zip disk, a magnetic tape, etc. The volatile read-and-write memory may include a random access memory (RAM). The RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. The ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 220 may store one or more programs and/or instructions to perform exemplary methods described in the present disclosure.

The I/O 230 may input and/or output signals, data, information, etc. In some embodiments, the I/O 230 may enable a user interaction with the processing engine 112. In some embodiments, the I/O 230 may include an input device and an output device. Examples of the input device may include a keyboard, a mouse, a touch screen, a microphone, or the like, or a combination thereof. Examples of the output device may include a display device, a loudspeaker, a printer, a projector, or the like, or a combination thereof. Examples of the display device may include a liquid crystal display (LCD), a light-emitting diode (LED)-based display, a flat panel display, a curved screen, a television device, a cathode ray tube (CRT), a touch screen, or the like, or a combination thereof.

The communication port 240 may be connected to a network (e.g., the network 120) to facilitate data communications. The communication port 240 may establish connections between the processing engine 112 and the sever 110, the storage device 130, the terminal device 140, and/or the third party platform 150. The connection may be a wired connection, a wireless connection, any other communication connection that can enable data transmission and/or reception, and/or any combination of these connections. The wired connection may include, for example, an electrical cable, an optical cable, a telephone wire, or the like, or any combination thereof. The wireless connection may include, for example, a Bluetooth™ link, a Wi-Fi™ link, a WiMax™ link, a WLAN link, a ZigBee link, a mobile network link (e.g., 3G, 4G, 5G, etc.), or the like, or a combination thereof. In some embodiments, the communication port 240 may be and/or include a standardized communication port, such as RS232, RS485, etc. In some embodiments, the communication port 240 may be a specially designed communication port.

FIG. 3 is a schematic diagram illustrating exemplary hardware and/or software components of an exemplary mobile device 300 according to some embodiments of the present disclosure. In some embodiments, the terminal device 140 may be implemented on one or more components the mobile device 300 to perform the functions of the terminal device 140 disclosed in the present disclosure.

As illustrated in FIG. 3, the mobile device 300 may include a communication platform 310, a display 320, a graphic processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to the credit assessment system 100. User interactions with the information stream may be achieved via the I/O 350 and provided to the processing engine 112 and/or other components of the credit assessment system 100 via the network 120. The communication platform 310 may be any information exchange port, information transmitting port, or network port to facilitate data communications.

To implement various modules, units, and their functionalities described in the present disclosure, computer hardware platforms may be used as the hardware platform(s) for one or more of the elements described herein (e.g., one or more components of the credit assessment system 100 described with respect to FIGS. 1-8). The hardware elements, operating systems and programming languages of such computers are conventional in nature, and it is presumed that those skilled in the art are adequately familiar therewith to adapt those technologies to provide a service in response to a voice request as described herein. A computer with user interface elements may be used to implement a personal computer (PC) or another type of work station or terminal device, although a computer may also act as a server if appropriately programmed. It is believed that those skilled in the art are familiar with the structure, programming and general operation of such computer equipment and as a result the drawings should be self-explanatory.

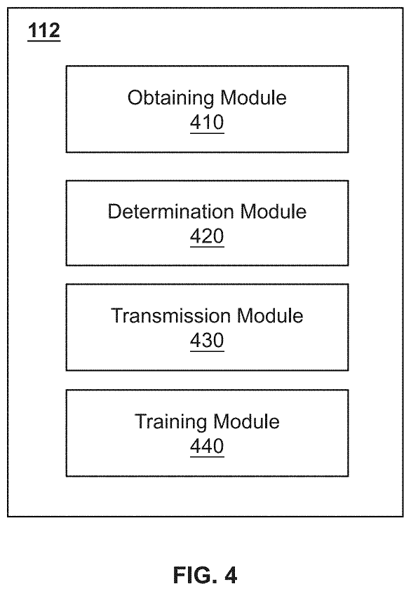

FIG. 4 is a block diagram illustrating an exemplary processing engine according to some embodiments of the present disclosure. The processing engine 112 may include an obtaining module 410, a determination module 420, a transmission module 430, and a training module 440. The modules may be hardware circuits of at least part of the processing engine 112. The modules may also be implemented as an application or set of instructions read and executed by the processing engine 112. Further, the modules may be any combination of the hardware circuits and the application/instructions.

The obtaining module 410 may be configured to obtain information related to the credit assessment system 100. For example, the obtaining module 410 may obtain or receive a request to determine a credit assessment score of a target entity. The request may be received from a terminal device 140 via a data communication port. As another example, the obtaining module 410 may be configured to acquire credit assessment information related to the target entity. The credit assessment information may include any information that reflects the credit status of the target entity, such as but not limited to profile information, financial information, one or more credit grades with respect to the target entity. In some embodiments, the obtaining module 410 may acquire the information related to the credit assessment system 100 from one or more components of the credit assessment system 100, such as the storage device 130, the storage 220. As another example, the obtaining module 410 may acquire the information related to the credit assessment system 100 from an external source (e.g., a third party platform 150) via the network 120.

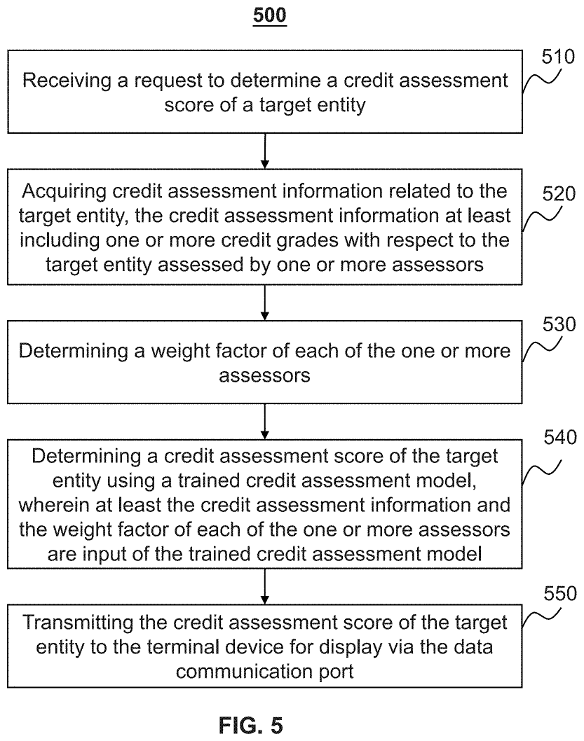

The determination module 420 may be configured to determine a credit assessment score of the target entity. The credit assessment score may be a quantitative measurement used to represent the credibility of the target entity. In some embodiments, the determination module 420 may determine a weight factor of each of the assessor(s) who assessed the target entity. The weight factor of an assessor may indicate an impact of the credit grade assessed by the assessor on the credit assessment score of the target entity. The determination module 420 may further determine the credit assessment score of the target entity using a trained credit assessment model, wherein at least the credit assessment information of the target entity and the weight factor of each of the one or more assessors may be an input of the trained credit assessment model. More descriptions regarding the determination of the weight factor and/or the credit assessment score may be found elsewhere in the present disclosure. See, e.g., FIG. 5 and the relevant descriptions thereof.

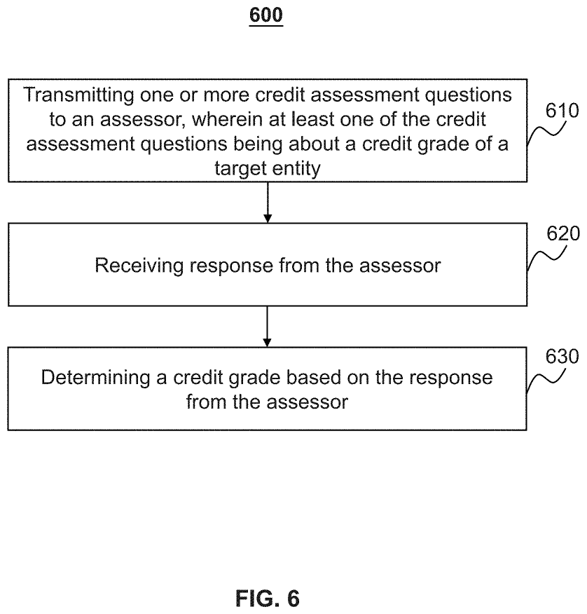

The transmission module 430 may be configured to transmit information and/or signals to one or more components of the credit assessment system 100 (e.g., the storage device 130 and/or the terminal device 140). Merely by way of example, the transmission module 430 may transmit the credit assessment score of the target entity to the terminal device 140 for display. As another example, in a process of collecting a credit grade with respect to the target entity as described elsewhere in this disclosure (e.g., FIG. 6 and the relevant descriptions), the transmission module 430 may be configured to transmit one or more credit assessment questions to an assessor. The credit assessment question(s) may be used to ask the assessor about the credit of the target entity.

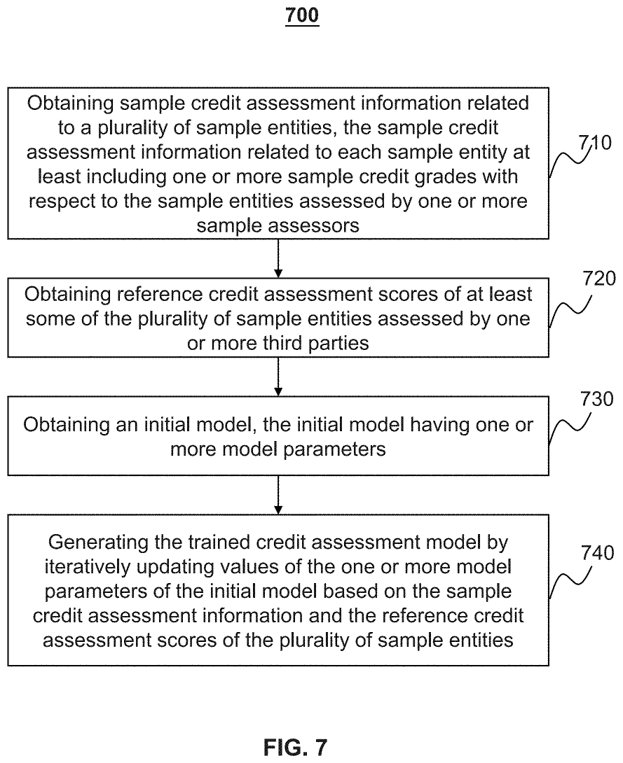

The training module 440 may be configured to train a model. For example, the training module 440 may determine the trained credit assessment model by training an initial model using information related to a plurality of sample entities. In some embodiments, the training module 440 may generate the trained credit assessment model based on a machine learning method, such as an artificial neural networks algorithm, a deep learning algorithm, a decision tree algorithm, an association rule algorithm, an inductive logic programming algorithm, a support vector machines algorithm, a clustering algorithm, a Bayesian networks algorithm, a reinforcement learning algorithm, a representation learning algorithm, a similarity and metric learning algorithm, a sparse dictionary learning algorithm, a genetic algorithms, a rule-based machine learning algorithm, or the like, or any combination thereof. More descriptions regarding the generation of the trained credit assessment model may be found elsewhere in the present disclosure. See, e.g., operation 540 and FIG. 7 and the relevant descriptions thereof.

It should be noted that the above description of the processing engine 112 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

For example, the processing engine 112 may further include one or more additional modules, such as a storage module (not shown in FIG. 4) for data storage. As another example, one or more modules of the processing engine 112 described above may be omitted. As yet another example, a module of the processing engine 112 described above may be divided into two or more sub-modules to perform the functions thereof. Merely by way of example, the determination module 420 may be divided into a first sub-module configured for determining the weight factor(s) of the assessor(s) and a second sub-module configured for determining the credit assessment score of the target entity.

In some embodiments, the obtaining module 410, the determination module 420, and the transmission module 430 may be implemented on a first processing engine, and the training module 440 may be implemented on a second processing engine. In some embodiments, the first and the second processing engines may respectively be implemented on a computing device 200 (e.g., the processor 220) illustrated in FIG. 2 or a CPU 340 as illustrated in FIG. 3. Merely by way of example, the first processing engine may be implemented on a CPU 340 of a mobile device and the second processing engine may be implemented on a computing device 200.

FIG. 5 is a flowchart illustrating an exemplary process for credit assessment according to some embodiments of the present disclosure. In some embodiments, the process 500 may be executed by the credit assessment system 100. For example, the process 500 may be implemented as a set of instructions (e.g., an application) stored in a storage device (e.g., the storage device 130, the storage 220) of the credit assessment system 100, and be invoked and/or executed by the processing engine 112 (e.g., the processor 210 as illustrated in FIG. 2, the CPU 340 illustrated in FIG. 3). The operations of the illustrated process 500 presented below are intended to be illustrative. In some embodiments, the process 500 may be accomplished with one or more additional operations not described and/or without one or more of the operations discussed. Additionally, the order in which the operations of the process 500 as illustrated in FIG. 5 and described below is not intended to be limiting.

In 510, the processing engine 112 (e.g., the obtaining module 410) may receive a request to determine a credit assessment score of a target entity. The request may be received from a terminal device 140 via a data communication port.

The target entity may be any individual, legal person, or organization whose credit assessment score is to be determined. In some embodiments, the request may be sent by a user of the terminal device 140. The user of the terminal device 140 may be any individual, legal person, or organization who wants to know the credit assessment score of the target entity. For example, an employer or a company may send a request to determine a credit assessment score of a job applicant employee. In some embodiments, the user may be the same entity as the target entity. In some embodiments, the target entity and/or the user may both be registered users of the credit assessment system 100.

In some embodiments, the request may include information (e.g., an ID, a name, and/or a telephone number) indicating the identity of the target entity. The user of the terminal device 140 may input the information and send the request via an I/O of the terminal device 140. In response to the received request, the processing engine 112 may identify the target entity according to the information included in the request.

The data communication port may be configured to establish a connection between the processing engine 112 and one or more other components in the credit assessment system 100, such as the terminal device 140 and/or the storage device 130. The connection may be a wired connection, a wireless connection, any other communication connection that can enable data transmission and/or reception, and/or any combination of these connections. In some embodiments, the data communication port may be similar to the communication port 240 described in FIG. 2, and the descriptions thereof are not repeated here.

In 520, the processing engine 112 (e.g., the obtaining module 410) may acquire credit assessment information related to the target entity.

The credit assessment information may include any information that reflects the credit status of the target entity. For example, the credit assessment information may include profile information, financial information, one or more credit grades with respect to the target entity, or the like, or any combination thereof. The profile information may include, for example, income, education level, job, marriage status, criminal records of the target entity, or the like, or any combination thereof. The financial information may include, for example, loan records, repayment records, credit card information, insurance information, or the like, or any combination thereof. The credit grade(s) with respect to the target entity may be a measurement of the credit of the target entity assessed by one or more assessors.

In some embodiments, the credit assessment information may at least include one or more credit grades with respect to the target entity. The credit grade(s) may be assessed by one or more assessors. The credit grade may be represented by, for example, a number, a level, a degree, a rating, or the like, or any combination thereof. For example, the credit grade may be represented by an integer in a range of [0, 10]. A higher value of the credit grade may indicate that the target entity has a better credit. As another example, the credit grade may be expressed in high or low ratings. The ratings may be denoted in Arabic numerals, Roman numerals, letters, or the like, or any combination thereof. For example, the credit grade may be represented by “A”, “AA”, “AAA”, in which “AAA” indicates the highest rating of credit, “AA” indicates the middle rating of credit, and “A” indicates the lowest rating of credit.

The assessor(s) of the credit grade(s) may be any individual, legal person, or organization that is capable of assessing the credit of the target entity. For example, the assessor(s) may include a friend, a relative, a colleague, a householder, a trading partner, or any other individual that knows the target entity. As another example, the assessor(s) may include a financial organization (e.g., a bank) that has financial information (e.g., debt record) of the target entity. In some embodiments, the target entity and/or the assessor(s) are registered users of the credit assessment system 100. In some embodiments, the credit assessment information may include the credit grade(s) with respect to the target entity assessed by all assessors that have assessed the target entity. Alternatively, the credit assessment information may include the credit grade(s) assessed by a portion of the assessors that have assessed the target entity, for example, one or more assessors who assessed the target entity in a predetermined period (e.g., recent three months), more assessors who are registered users of the credit assessment system 100, one or more assessors whose reference credit assessment scores are greater than a threshold, one or more assessors whose reference credit assessment scores are among the top list (e.g., top thirty percent, top fifty percent, top eighty percent), or the like, or any combination thereof.

In some embodiments, the credit assessment information related to the target entity may further include information related to the credit grade(s) assessed by the assessor(s), such as time information related to each credit grade, a source from which each credit grade is acquired, a relationship between the target entity and each assessor, a scenario in which each credit grade was assessed by the corresponding assessor, credit information of each assessor, the number of the credit grade(s), the number of the assessor(s), a change of the credit grade(s), a punishment coefficient regarding false assessments, or the like, or any combination thereof.

The time information related to a credit grade assessed by an assessor may include a first time point when the assessor was invited to make the credit grade, a second time point time when the assessor gave the credit grade, a time interval between the first time point and the second time point, or the like, or any combination thereof. The source from which a credit grade is acquired may include a credit assessment platform provided by the credit assessment system 100 and/or a third party platform 150, or the like, or any combination thereof. The relationship between the target entity and an assessor may include a friend relationship, a relative relationship, a colleague relationship, a householder relationship, a trading partner relationship, or the like, or any combination thereof. The scenario in which a credit grade was assessed by an assessor may include, for example, a scenario in which the target entity and the assessor were involved in a transaction, a scenario in which the assessor loaned money to the target entity, a scenario in which the assessor has been a friend of the target entity for many years, or the like, or any combination thereof. The credit information of an assessor may include profile information, financial information, one or more credit assessments (e.g., a credit grade, a credit assessment score, a credit assessment comment) with respect to the assessor made by others (e.g., a third party platform), one or more credit assessments (e.g., a credit grade, a credit assessment score, a credit assessment comment) made by the assessor with respect to others (e.g., other registered users of the credit assessment system 100), or the like, or any combination thereof. The number of the credit grade(s) may include a total number of the credit grade(s) of the target entity, a proportion of the credit grade(s) in all credit grades in the credit assessment system 100, and a rank of the target entity among all registered users of the credit assessment system 100 according to the total number of the credit grade(s) of the target entity and the total number of the credit grade of each registered user. The number of the assessor(s) may include a total number of the assessor(s) of the target entity, a proportion of the assessor(s) in all registered users of the credit assessment system 100, and a rank of the target entity among all registered users of the credit assessment system 100 according to the total number of the assessors of the target entity and the total number of the assessors of each registered user. The change of the credit grade(s) assessed by the assessor(s) may be represented by the number of credit grades of the target entity received in a certain period (e.g., in recent three months), the number of assessors who assessed the target entity in a certain period (e.g., in recent three months), the number of times that the target entity and the assessor(s) assess each other in a certain period (e.g., in recent three months), the number of assessors who have been assessed by the target entity in a certain period (e.g., in recent three months), a change of a statistical value of the credit grades in different time periods, for example, an average value of the credit grades in the last month, the last three months, and the last six month. As used herein, the target entity and a certain assessor may be regarded as assessing each other if the target entity has assessed the certain assessor and the certain assessor has assessed the target entity. The punishment coefficient regarding false assessments may reflect a possibility that an assessor gives a false credit grade. The punishment coefficient may be measured by, for example, an average time interval between consecutive mutual assessments of the assessor and the target entity, in case that the assessor and the target entity may cheat by assessing each other frequently.

Additionally or alternatively, the credit assessment information may also include information related to one or more credit assessments given by the target entity with respect to other entities (e.g., other registered users of the credit assessment system 100), including, for example, the number of times that the target entity assessed other entities, the number the other entities that have been assessed by the target entity, a relationship between the target entity and each of the other entities, or the like, or any combination thereof.

In some embodiments, the obtaining module 410 may acquire at least part of the credit assessment information from a storage device of the credit assessment system 100, such as the storage device 130, the storage 220. Take a credit grade of the target entity as an example, the obtaining module 410 may retrieve the credit grade from the storage device. The credit grade may be acquired by a credit grade collection process, and stored in the storage device. Details regarding the credit grade collection process may be found elsewhere in the present disclosure (e.g., FIG. 6 and the relevant descriptions thereof). Alternatively, the credit grade may be acquired from a third party platform 150, and stored in the storage device. For example, the credit assessment system 100 (e.g., the processing engine 112) may periodically obtain one or more credit grades of the target entity from the third party platform 150 and store them in the storage device 130.

In some embodiments, the obtaining module 410 may acquire at least part of the credit assessment information from an external source via the network. For example, the credit grade may be acquired directly from the third party platform 150 via the network 120. In some embodiments, the credit grade acquired from the third party platform 150 may be determined by the third party platform 150. In such case, the assessor of the credit grade may be the third party platform 150. Alternatively, the credit grade acquired from the third party platform 150 may be assessed by another user of the third party platform 150 on the third party platform 150. In such case, the assessor of the credit grade may be the user who assesses the credit grade. In some embodiments, the obtaining module 410 may acquire a credit comment with respect to the target entity from the third party platform 150 via the data communication port. The determination module 420 may then determine a credit grade with respect to the target entity based on the credit comment. The credit comment may be in the form of text, such as “the target entity is trustworthy and always keeps his words”. The determination module 420 may perform a text analysis on the credit comment and determine a corresponding credit grade.

In some embodiments, the obtaining module 410 may obtain the same form or different forms of credit grades regarding the target entity from different sources. For example, the credit grade obtained from a bank platform 150-1 may be in the form of numbers, while the credit grade obtained from a transaction platform 150-2 may be in the form of ratings. As another example, the credit grades obtained from different platforms may be in different ranges. The determination module 420 may normalize the credit grades obtained from different sources in a standard form and/or a standard range. In some embodiments, the credit assessment system 100 may cooperate with a third party platform 150 so that the third party platform 150 may provide a standard form of credit grades to the credit assessment system 100.

In 530, the processing engine 112 (e.g., the determination module 420) may determine a weight factor of each of the one or more assessors.

A weight factor of an assessor may indicate an impact of the credit grade assessed by the assessor on the credit assessment score of the target entity. For example, if a first assessor has a higher weight factor than a second assessor, the credit grade assessed by the first assessor may have a greater impact on the credit assessment score than that assessed by the second assessor. Normally, different assessors, such as different people or organizations may have different credibility. Therefore, the credit grades assessed by different assessors may need to be assigned with different weights in the determination of the credit assessment score of the target entity.

The weight factor(s) of the assessor(s) may be determined by various techniques. In some embodiments, the determination module 420 may determine the weight factor(s) of the assessor(s) at least based on the type of the assessor(s). Merely by way of example, an institution may be assigned with a higher weight factor than an individual. As another example, an authoritative institution (e.g., a bank or a credit bureau certified by the state) may have a higher weight factor than other institutions.

In some embodiments, the determination module 420 may determine the weight factor(s) of the assessor(s) at least based on one or more reference credit assessment scores of the assessor(s). The reference credit assessment score of an assessor may refer to a credit assessment score of the assessor evaluated by a third party platform 150 (e.g., a credit bureau or a bank). Normally, a third party platform 150, such as a credit bureau or a bank may evaluate the assessor(s) based on objective behavior or profile information of the assessor, providing a relatively reliable credit assessment of the assessor. Therefore, the reference credit assessment score of the assessor may be used to determine the weight factor of the assessor and verify the reliability of the credit grade made by the assessor. For example, the determination module 420 may assign a higher weight factor on an assessor A than an assessor B if A has a higher reference credit assessment score than B. In some embodiments, the reference credit assessment scores of different assessors may be evaluated by the same third party platform 150 or different third party platforms 150.

In some embodiments, one or more of the assessor(s) may be registered user(s) of the credit assessment system 100. The credit assessment score(s) of the registered assessor(s) may be determined, for example, by performing process 500, and stored in a storage device (e.g., the storage device 130) of the credit assessment system 100. The determination module 420 may obtain the credit assessment scores of the registered user(s) from the storage device. The determination module 420 may then determine the weight factor(s) of the registered assessor(s) based on the credit assessment score(s) of the registered assessors.

In some embodiments, if the determination module 420 fails to determine a weight factor of an assessor according to a credit assessment score or a reference credit assessment score of the assessor. The determination module 420 may assign a default weight factor to the assessor, for example, depending on the type of the assessor. The default weight factor may be manually set by a user of the credit assessment system 100. In some embodiments, the determination module 420 may select one or more of the assessor(s) who have the top N (e.g., 3, 5, 10%, or 50%) credit assessment scores or reference credit assessment scores, and assign them with weight factors. Only weight factor(s) of the selected assessor(s) may be used in the determination of the credit assessment score of the target entity. Alternatively, the weight factors of the unselected assessor(s) may be set as zero, The weight factors of selected and unselected assessor(s) may both be used in the determination of the credit assessment score of the target entity.

In 540, the processing engine 112 (e.g., the determination module 420) may determine a credit assessment score of the target entity using a trained credit assessment model. At least the credit assessment information and the weight factor of each of the one or more assessors may be an input of the trained credit assessment model.

The credit assessment score may be a quantitative measurement used to represent the credibility of the target entity. A higher credit assessment score may indicate that the target entity has a better credibility and a lower probability of default in, for example, financial lending, life service, or other scenarios. The credit assessment score may be denoted in a number, a character, a symbol, or the like, or any combination thereof. For example, the credit assessment score may be represented as a numerical value in a range of 0 to 100. As another example, the credit assessment score may be represented as A, AA. or AAA.

The trained credit assessment model may be configured to determine the credit assessment score of the target entity based on the input. In some embodiments, the trained credit assessment model may be acquired by the obtaining module 410 from a storage device in the credit assessment system 100 (e.g., the storage device 130) and/or an external data source (not shown). In some embodiments, the processing engine 112 (e.g., the training module 440) may determine the trained credit assessment model, and store it in the storage device of the credit assessment system 100. The obtaining module 410 may access the storage device and retrieve the trained credit assessment model. Alternatively, the trained credit assessment model may be determined by another computing device (or a processor thereof), and the obtaining module 410 obtain the trained credit assessment model from the another computing device (or a storage device that stores the trained credit assessment model).

In some embodiments, the processing engine 112 (or another computing device) may generate the trained credit assessment model based on a machine learning method. The machine learning method may include but not be limited to an artificial neural networks algorithm, a deep learning algorithm, a decision tree algorithm, an association rule algorithm, an inductive logic programming algorithm, a support vector machines algorithm, a clustering algorithm, a Bayesian networks algorithm, a reinforcement learning algorithm, a representation learning algorithm, a similarity and metric learning algorithm, a sparse dictionary learning algorithm, a genetic algorithms, a rule-based machine learning algorithm, or the like, or any combination thereof. In some embodiments, the processing engine 112 (or another computing device) may determine the trained credit assessment model by performing one or more operations in process 700 illustrated in FIG. 7.

In 550, the processing engine 112 (e.g., the transmission module 430) may transmit the credit assessment score of the target entity to the terminal device 140 for display via the data communication port.

The credit assessment score of the target entity may be displayed on the terminal device 140 in a form of voice, text, graph, image, or the like, or any combination thereof. For example, the credit assessment score of the target entity may be displayed as text, such as “30 points”, “60 points”, or “75 points”, on an interface of the terminal device 140. As another example, the credit assessment score of the target entity may be broadcasted by the terminal device 140. In some embodiments, the credit assessment score of the target entity may be displayed on or by an APP for credit assessment service installed on the terminal device 140.

It should be noted that the descriptions regarding the process 500 are provided for the purposes of illustration, not intended to limit the scope of the present disclosure. For persons having ordinary skills in the art, multiple variations and modifications may be reduced to practice in the light of the present disclosure. However, those variations and modifications do not depart from the scope of the present disclosure.

In some embodiments, an operation in process 500 may be divided into a plurality of sub-operations. Merely by way of example, operation 540 may be divided into a first sub-operation and a second sub-operation. In the first sub-operation, the training module 440 may generate the trained credit assessment model. In the second sub-operation, the determination module 420 may determine the credit assessment score of the target entity by inputting at least the credit assessment information and the weight factor of each of the one or more assessors. In some embodiments, operation 530 may be omitted. In 540, the determination module 420 may determine the credit assessment score of the target entity by inputting the credit assessment information of the target entity into the trained credit assessment model.

In some embodiments, considering that the credit assessment information of the target entity and/or the weight factor(s) of the assessor(s) may change over time, the processing engine 112 may update the credit assessment score of the target entity regularly or irregularly. For example, the processing engine 112 may perform the process 500 periodically to update the credit assessment score of the target entity. Alternatively, the processing engine 112 may perform one or more additional operations to update the weight factor(s) of the assessor(s) determined in operation 530. Merely by way of example, the processing engine 112 (e.g., the obtaining module 410) acquire the determined weight factor(s) of the assessor(s). The processing engine 112 (e.g., the obtaining module 410) may acquire a new reference credit assessment score of at least one of the assessor(s). For example, a third party platform 150 may determine a new reference credit assessment score of the at least one assessor based on a new record (e.g., a loan record) of the at least one assessor. The third party platform 150 may transmit the new reference credit assessment score to the obtaining module 410. In response to the new reference credit assessment score, the determination module 420 may update the weight factor(s) of the assessor(s). After the weight factor(s) are updated, the processing engine 112 may perform operation 540 based on the credit assessment information and the updated weight factor(s).

In some embodiments, after the credit assessment score of the target entity is determined, the processing engine 112 may further verify the credit assessment score. For example, for a target entity having a reference credit assessment score evaluated by an authoritative institution (e.g., a bank), the processing engine 112 may perform a correlation analysis between the reference credit assessment score and the credit grade(s) of the target entity. If the difference between the reference credit assessment score and the average credit grade exceeds a threshold, the processing engine 112 may check the credit grade(s) of the target entity. As another example, for a target entity who does not have a reference credit assessment score, the processing engine 112 may predict a reference credit assessment score based on the correlation between the credit grade(s) and reference credit assessment score of other entities. Optionally, the processing engine 112 may verify the credit assessment score of the target entity based on the credit grade(s) and the predicted reference credit assessment score of the target entity.

FIG. 6 is a flowchart illustrating an exemplary process for determining a credit grade with respect to a target entity according to some embodiments of the present disclosure. In some embodiments, the process 600 may be executed by the credit assessment system 100. For example, the process 600 may be implemented as a set of instructions (e.g., an application) stored in a storage device (e.g., the storage device 130, the storage 220) of the credit assessment system 100, and be invoked and/or executed by the processing engine 112 (e.g., the processor 210 as illustrated in FIG. 2, the CPU 340 illustrated in FIG. 3). The operations of the illustrated process 600 presented below are intended to be illustrative. In some embodiments, the process 600 may be accomplished with one or more additional operations not described and/or without one or more of the operations discussed, Additionally, the order in which the operations of the process 600 as illustrated in FIG. 6 and described below is not intended to be limiting. In some embodiments, one or more operations in FIG. 6 may be performed to achieve at least a portion of the operation 520 as described in connection with FIG. 5. In some embodiments, the process 600 may also be referred to as a credit grade collection process.

In 610, the processing engine 112 (e.g., the transmission module 430) may transmit one or more credit assessment questions to an assessor. The credit assessment question(s) may be used to ask the assessor about the credit of the target entity. The credit assessment question(s) may be about, for example, the credit grade of the target entity, the reason for giving the credit grade, the relationship between the assessor and the target entity, a comment regarding the credit of the target entity, or the like, or any combination thereof. In some embodiments, at least one of the credit assessment question(s) may be about the credit grade of the target entity.

In some embodiments, the target entity and assessor may be registered users of the credit assessment system 100. The credit assessment system 100 may provide a platform for user assessment, such as an APP, a website, a WeChat subscription, or the like. The assessor may transmit a request to evaluate the target entity to the platform. The platform may then transmit the credit assessment question(s) to the assessor. Additionally or alternatively, the target entity may invite the assessor to give a credit assessment about the target entity. For example, the target entity may send a link or a message including the credit assessment question(s) to a terminal device of the assessor,

In 620, the processing engine 112 (e.g., the obtaining module 410) may receive a response from the assessor. Upon receiving the credit assessment question(s), the assessor may input the response and transmit it back to the processing engine 112 via the terminal device.

In 630, the processing engine 112 (e.g., the determination module 420) may determine a credit grade based on the response from the assessor. In some embodiments, the response of the assessor may include the credit grade regarding the target entity evaluated by the assessor. The determination module 420 may extract the corresponding credit grade from the response of the assessor. Alternatively, the response of the assessor may include, for example, a comment regarding the target entity other than the credit grade. The determination module 420 may determine the credit grade according to the comment regarding the target entity.

It should be noted that the above description of the process 600 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

FIG. 7 is a flowchart illustrating an exemplary process for generating a trained credit assessment model according to some embodiments of the present disclosure. In some embodiments, the process 700 may be executed by the credit assessment system 100. For example, the process 700 may be implemented as a set of instructions (e.g., an application) stored in a storage device (e.g., the storage device 130, the storage 220) of the credit assessment system 100, and be invoked and/or executed by the processing engine 112 (e.g., the processor 210 as illustrated in FIG. 2, the CPU 340 illustrated in FIG. 3). Alternatively, the process 700 may be executed by another computing device (or a processor thereof). For brevity and illustration purposes, only the processing engine 112 is used to describe the process of generating the trained credit assessment model, but one having ordinary skills in the art would understand that a different computing device may execute the process of generating the trained credit assessment model. In some embodiments, one or more operations of the process 700 may be performed to achieve at least part of operation 540 as described in connection with FIG. 5.

In 710, the processing engine 112 (e.g., the training module 440) may obtain sample credit assessment information related to a plurality of sample entities. The sample credit assessment information related to each sample entity may at least include one or more sample credit grades with respect to the sample entities assessed by one or more sample assessors.

The sample entities may include any entity that can be used as a sample in the training of the credit assessment model. For example, the sample entities may include one or more registered users of the credit assessment system 100. As another example, the sample entities may include one or more entities whose credit information (e.g., sample credit assessment information and/or reference credit assessment scores) is available for the processing engine 112. The sample credit assessment information related to a sample entity may include any information that reflects the credit status of the sample entity. For example, the sample credit assessment information related to the sample entity may include profile information, financial information, one or more sample credit grades with respect to the sample entity, or the like, or any combination thereof. The sample credit assessment information and the sample credit grade(s) related to the sample entity may be similar to the credit assessment information and the credit grade(s) related to a target entity, respectively, as described in connection with operation 510, and the descriptions thereof are not repeated here. The reference credit assessment score related to a sample entity may refer to a credit assessment score of the entity that is evaluated by a third party platform 150 (e.g., a bank platform, a loan platform, a credit bureau platform, a lending platform, a social network platform, a renting platform, a transaction platform, or an online to offline service platform).

In some embodiments, the sample credit assessment information related to a sample entity may be expressed as a feature vector that includes one or more features of the sample entity. An N-dimensional vector may be associated with N features. In some embodiments, the processing engine 112 (e.g., the training module 440) may process one or more feature vectors at once. For example, m feature vectors having N dimensions (e.g., three-row vectors) may be integrated into a 1×mN vector or an m×N matrix, where m is an integer.

In 720, the processing engine 112 (e.g., the training module 440) may obtain reference credit assessment scores of at least some of the plurality of sample entities.

In some embodiments, a reference credit assessment score of a sample entity may be obtained from the third party platform 150 via the network 120. Alternatively, the reference credit assessment score of the sample entity may be obtained from a storage device (e.g., the storage device 130) of the credit assessment system 100. For example, one or more third party platforms 150 may regularly or irregularly transmit the latest reference credit assessment score(s) of one or more sample entities to the credit assessment system 100, which may be stored in the storage device of the credit assessment system 100. In some embodiments, the reference credit assessment scores of different sample entities may be obtained from different third party platforms. The training module 440 may normalize the reference credit assessment scores of the at least some of the sample entities into the same range or form.

In some embodiments, the at least some of the sample entities may be used as a training set to train the initial mod& in operation 730. Alternatively, only a selected portion of the at least some of the sample entities may be used as the training set to train the initial mod& in operation 730. The selected portion may be selected randomly or according to a selection rule. For example, the selected portion may include one or more sample entities who have the highest N reference credit assessment scores and/or one or more sample entities who have the lowest M reference credit assessment scores. The N and M may be any suitable integer (e.g., 50, 100, 1000) or percentage (10%, 20%, 30%).

In 730, the processing engine 112 (e.g., the obtaining module 410) may obtain an initial model.

The initial model may include a machine learning model, such as a random forest model, an Extreme Gradient Boosting (XGboost) model, a decision tree model, and a logistic regression model. The initial model may have one or more model parameters. Taking an XGboost model as an example, the initial model may include one or more model parameters, such as a booster type (e.g., tree-based model or linear model), a booster parameter (e.g., a maximum depth, a maximum number of leaf nodes), a learning task parameter (e.g., an objective function of training), or the like, or any combination thereof. In some embodiments, the initial model may have initial value(s) of the one or more model parameters. The initial value(s) of the model parameter(s) may be manually set by a user of the credit assessment system 100 via, for example, a terminal device 140. Additionally or alternatively, the initial value(s) of the model parameter(s) may be adaptively set by the processing engine 112 according to different situations.

In 740, the processing engine 112 (e.g., the training module 440) may generate the trained credit assessment model by iteratively updating values of the one or more model parameters of the initial model based on the sample credit assessment information and the reference credit assessment scores of the at least some of the plurality of sample entities.

The generation of the trained credit assessment model may include one or more iterations. In each iteration, the training module 440 may input the sample credit assessment information of each sample entity in the training set into the initial model updated in the previous iteration to determine a predict credit assessment score of each sample entity. The training module 440 may then determine the value of an objective function based on the predicted credit assessment scores and the reference credit assessment scores of the sample entities in the training set. The training module 440 may further update the initial model by updating the values of the model parameter(s) based on the value of the objective function.

In some embodiments, the model parameter(s) may be updated iteratively in order to minimize the value of the objective function. The iteration to minimize the value of the objective function may be terminated until a termination condition is satisfied. An exemplary termination condition is that the value of the objective function obtained in an iteration is less than a predetermined threshold. The predetermined threshold may be set manually or determined based on various factors including, such as the accuracy of the trained credit assessment model, etc. Other exemplary termination conditions may include that a certain count of iterations are performed, that the objective function converges such that the differences of the values of the objective function obtained in consecutive iterations are within a threshold, etc. After the termination condition is satisfied in a certain iteration, the initial model having the updated value(s) of the model parameter(s) may be designated as the trained credit assessment model.

In some embodiments, the objective function may include a loss function and/or a regularization term. The loss function may measure how well the initial model updated in the previous iteration fits with the training data. The regularization factor may measure the complexity of the initial model updated in the previous iteration. Exemplary loss functions may include a 0-1 loss function, a quadratic loss function, an absolute loss function, a logarithmic loss function, a log-likehood loss function, an Adaboost loss function, a Hinge loss function, a mean absolute percent error (MAPE), a mean squared error (MSE), a root mean square error (RMSE), or the like. Exemplary regularization terms may include L1-norm, L2-norm, or the like.

It should be noted that the flowchart described above is provided for the purposes of illustration, not intended to limit the scope of the present disclosure. For persons having ordinary skills in the art, multiple variations and modifications may be reduced to practice in the light of the present disclosure. However, those variations and modifications do not depart from the scope of the present disclosure.

The operations of the illustrated process presented below are intended to be illustrative. In some embodiments, the process 700 may be accomplished with one or more additional operations not described and/or without one or more of the operations discussed. For example, an operation may be added after 740 to test the credit assessment model using a testing set (e.g., a certain portion of the at least part of the sample entities). Additionally, the order in which the operations of the process as illustrated in FIG. 7 and described below is not intended to be limiting.

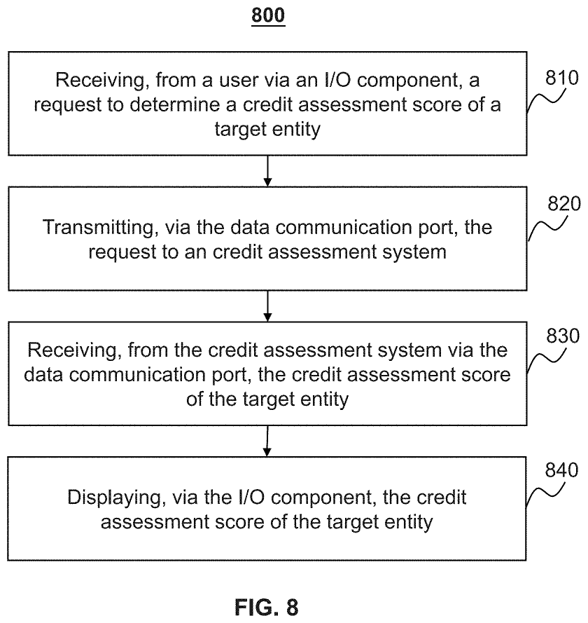

FIG. 8 is a flowchart illustrating an exemplary process for credit assessment according to some embodiments of the present disclosure. In some embodiments, the process 800 may be executed by a terminal device 140 of the credit assessment system 100. The terminal device 140 may be implemented on one or more same or similar components of the mobile device 300 as described in connection with FIG. 3. For example, the terminal device 140 may include a data communication port communicatively connected to a network, an I/O component, a storage medium (e.g., a storage or memory), and a processor.

In some embodiments, the process 800 may be implemented as a set of instructions (e.g., an application) stored in the storage medium (e.g., the memory and/or the storage) of the terminal device 140, and be invoked and/or executed by the processor (e.g., the CPU and/or the GPU) of the terminal device 140. The operations of the illustrated process presented below are intended to be illustrative. In some embodiments, the process 800 may be accomplished with one or more additional operations not described and/or without one or more of the operations discussed. Additionally, the order in which the operations of the process as illustrated in FIG. 8 and described below is not intended to be limiting.

In 810, the terminal device 140 may receive a request to determine a credit assessment score of a target entity. The request may be received from a user via the I/O component of the terminal device 140. In some embodiments, the user may input the request via the I/O component by typing, speaking, and/or touching the I/O component. The request to determine the credit assessment score of the target entity may be similar to that described in connection with operation 510, and the descriptions thereof are not repeated here.

In 820, the terminal device 140 may transmit the request to the credit assessment system 100 via its data communication port. In some embodiments, the request may be transmitted to the server 110 (e.g., the processing engine 112) of the credit assessment system 100. In response to the request, the processing engine 112 may perform a process for credit assessment (e.g., the process 500) disclosed in the present disclosure. For example, the processing engine 112 may acquire credit assessment information related to the target entity. The credit assessment information related to the target entity may include one or more credit grades with respect to the target entity assessed by one or more assessors. The processing engine 112 may determine a weight factor of each of the one or more assessors. The processing engine 112 may further determine a credit assessment score of the target entity using a trained credit assessment model based on the credit assessment information and the weight factor(s) of the assessor(s).

In 830, the terminal device 140 may receive the credit assessment score of the target entity from the credit assessment system 100 via the data communication port of the terminal device 140.

As described in connection with operation 820, the credit assessment score of the target entity may be determined by the credit assessment system 100 (e.g., the processing engine 112) at least based on the credit assessment information related to the target entity and the weight factor of each assessor of the target entity. Additionally or alternatively, the credit assessment score may be determined by the credit assessment system 100 (e.g., the processing engine 112) based on the trained credit assessment model. The credit assessment information and the weight factor of each assessor may be an input of the trained credit assessment model.

In 840, the terminal device 140 may display the credit assessment score of the target entity via the I/O component.

The credit assessment score of the target entity may be displayed on the terminal device 140 in a form of voice, text, graph, image, or the like, or any combination thereof. Details regarding the display of the credit assessment score by the terminal device 140 may be found elsewhere in the present disclosure (e.g., operation 550 and the relevant descriptions thereof).

It should be noted that description regarding the process 800 is provided for the purposes of illustration, not intended to limit the scope of the present disclosure. For persons having ordinary skills in the art, multiple variations and modifications may be reduced to practice in the light of the present disclosure. However, those variations and modifications do not depart from the scope of the present disclosure. In some embodiments, the credit assessment system 100 (e.g., the processing engine 112) may transmit the credit assessment score of the target entity to the terminal device 140 only if a certain condition is satisfied. For example, the processing engine 112 may ask for a permission from the target entity. The credit assessment score of the target entity may be transmitted to the terminal device 140 only if the target entity permits to do so. As another example, the processing engine 112 may transmit the credit assessment score of the target entity only if the request is sent by a user who is a friend of the target entity on the credit assessment system 100.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer-readable medium having computer readable program code embodied thereon.

A computer readable signal medium may include a propagated data signal with computer readable program code embodied therein, for example, in baseband or as part of a carrier wave. Such a propagated signal may take any of a variety of forms, including electromagnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB. NET, Python or the like, conventional procedural programming languages, such as the “C” programming language, Visual Basic, Fortran 2103, Perl, COBOL 2102, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, for example, an installation on an existing server or mobile device.

Similarly, it should be appreciated that in the foregoing description of embodiments of the present disclosure, various features are sometimes grouped together in a single embodiment, figure, or description thereof to streamline the disclosure aiding in the understanding of one or more of the various inventive embodiments. This method of disclosure, however, is not to be interpreted as reflecting an intention that the claimed object matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A system, comprising:
a data communication port communicatively connected to, via a network, a plurality of registered terminal devices of a credit assessment system and at least one third party platform for storing credit assessment information relating to users of at least part of the plurality of registered terminal devices;
at least one storage medium storing a set of instructions for credit assessment;
at least one processor configured to communicate with the at least one storage medium and the data communication port, wherein when executing the set of instructions, the at least one processor is configured to direct the system to:
receive, from a terminal device among the plurality of registered terminal devices via the data communication port, a request to determine a credit assessment score of a target entity;
acquire credit assessment information related to the target entity, the credit assessment information at least including one or more credit grades with respect to the target entity assessed by one or more assessors, at least one credit grade of the one or more credit grades of the target entity being acquired from a third party platform of the at least one third party platform;
determine a weight factor of each of the one or more assessors;
determine a credit assessment score of the target entity using a trained credit assessment model, wherein at least the credit assessment information and the weight factor of each of the one or more assessors are an input of the trained credit assessment model, and the trained credit assessment model is trained using a machine learning algorithm and stored in the at least one storage medium; and
transmit the credit assessment score of the target entity to the terminal device for display via the data communication port.

2. The system of claim 1, wherein the at least one third party platform includes at least one of a bank platform, a loan platform, a credit bureau platform, a lending platform, a social network platform, a renting platform, a transaction platform, or an online to offline service platform.

3. The system of claim 1, wherein to acquire the at least one credit grade from the third party platform, the at least one processor is further configured to direct the system to:
acquire, from the third party platform via the data communication port, a credit comment corresponding to the at least one credit grade with respect to the target entity; and
determine the at least one credit grade based on the credit comment.

4. The system of claim 1, wherein at least one credit grade of the one or more credit grades of the target entity is acquired by a credit grade collection process, the credit grade collection process including:
transmitting one or more credit assessment questions to the corresponding assessor, wherein at least one of the credit assessment questions being about the credit grade of the target entity;
receiving a response from the corresponding assessor; and
determining the at least one credit grade based on the response from the corresponding assessor.

5. The system of claim 1, wherein the credit assessment information related to the target entity further includes at least one of time information related to each credit grade, a source from which each credit grade is acquired, a relationship between the target entity and each assessor, or a scenario in which each credit grade was assessed by the corresponding assessor, or credit information of each assessor.

6. The system of claim 1, wherein the target entity and the one or more assessors are registered users of the credit assessment system.

7. The system of claim 1, wherein to determine the weight factor of each of the one or more assessors, the at least one processor is further configured to direct the system to:
determine the weight factors of the one or more assessors at least based on one or more reference credit assessment scores of the one or more assessors.

8. The system of claim 7, wherein to determine the weight factor of each of the one or more assessors, the at least one processor is further configured to direct the system to:
acquire the one or more weight factors of the one or more assessors;
acquire a new reference credit assessment score of at least one of the assessors, and
update the one or more weight factors of the one or more assessors based on the new reference credit assessment score of the at least one of the assessors.

9. The system of claim 1, wherein the trained credit assessment model is trained according to a model training process, the model training process including:
obtaining sample credit assessment information related to a plurality of sample entities, the sample credit assessment information related to each sample entity at least including one or more sample credit grades with respect to the sample entities assessed by one or more sample assessors;
obtaining reference credit assessment scores of at least some of the plurality of sample entities;
obtaining an initial model, the initial model having one or more model parameters; and
generating the trained credit assessment model by iteratively updating values of the one or more model parameters of the initial model based on the sample credit assessment information and the reference credit assessment scores of the at least some of the plurality of sample entities.

10. The system of claim 9, wherein the trained credit assessment model is at least one of a random forest model, an XGboost model, a decision tree model, or a logistic regression model.

11. A system, comprising:
a data communication port communicatively connected to a network;
at least one storage medium storing a set of instructions for generating a trained credit assessment model;
at least one processor configured to communicate with the at least one storage medium and the data communication port, wherein when executing the set of instructions, the at least one processor is configured to direct the system to:
obtain sample assessment information related to a plurality of sample entities, the sample credit assessment information related to each sample entity at least including one or more sample credit grades with respect to the sample entities assessed by one or more sample assessors;
obtain reference credit assessment scores of at least some of the sample entities;
obtain an initial model, the initial model having one or more model parameters;
generate the trained credit assessment model by iteratively updating values of the one or more model parameters of the initial model based on the sample credit assessment information and the reference credit assessment scores of the at least some of the plurality of sample entities; and
store the trained credit assessment model in the at least one storage medium.

12. The system of claim 11, wherein the trained credit assessment model is at least one of a random forest model, an XGboost model, a decision tree model, or a logistic regression model.

13. A terminal device, comprising:
a data communication port communicatively connected to, via a network, a credit assessment system;
an I/O component;
at least one storage medium storing a set of instructions;
at least one processor configured to communicate with the at least one storage medium and the data communication port, wherein when executing the set of instructions, the at least one processor is configured to direct the terminal device to:
receive, from a user via the I/O component, a request to determine a credit assessment score of a target entity;
transmit, via the data communication port, the request to the credit assessment system;
receive, from the credit assessment system via the data communication port, the credit assessment score of the target entity; and
display, via the I/O component, the credit assessment score of the target entity, wherein the credit assessment score of the target entity is determined at least based on:
credit assessment information related to the target entity, the credit assessment information at least including one or more credit grades with respect to the target entity assessed by one or more assessors, and
a weight factor of each of the one or more assessors.

14. The terminal device of claim 13, wherein the credit assessment score is determined further based on a trained credit assessment model, and the credit assessment information and the weight factor of each of the one or more assessors are an input of the trained credit assessment model.

15. The terminal device of claim 13, wherein the credit assessment information related to the target entity further includes at least one of time information related to the one or more credit grades, a source from which each credit grade is acquired, a relationship between the target entity and each assessor, or a scenario in which each credit grade was assessed by the corresponding assessor, or credit information of each assessor.

16. The terminal device of claim 13, wherein the weight factor of each of the one or more assessors is at least based on one or more reference credit assessment scores of the one or more assessors.

17-29. (canceled)

30. The system of claim 1, wherein the at least one processor is further configured to direct the system to:
for each of the one or more assessors,
obtain information relating to mutual assessment between the assessor and the target entity; and
determine, based on the information relating to mutual assessment between the assessor and the target entity, a punishment coefficient of the assessor, wherein the input of the trained credit assessment model further includes the punishment coefficient of each of the one or more assessors.

31. The system of claim 1, wherein the at least one processor is further configured to direct the system to:
obtain a reference credit assessment score of the target entity; and
verify the credit assessment score of the target entity by comparing the credit assessment score and the reference credit assessment score.

32. The system of claim 31, wherein to obtain a reference credit assessment score of the target entity, the at least one processor is further configured to direct the system to:
predict, based on a correlation between credit grades and reference credit assessment scores of other entities registered on the credit assessment system, the reference credit assessment score of the target entity.

33. The system of claim 11, the at least one processor is further configured to direct the system to:
receive, from a terminal device, a request to determine a credit assessment score of a target entity;
acquire credit assessment information related to the target entity, the credit assessment information at least including one or more credit grades with respect to the target entity assessed by one or more assessors, at least one credit grade of the one or more credit grades of the target entity being acquired from a third party platform;
determine a weight factor of each of the one or more assessors;
determine a credit assessment score of the target entity using the trained credit assessment model, wherein at least the credit assessment information and the weight factor of each of the one or more assessors are an input of the trained credit assessment model; and
transmit the credit assessment score of the target entity to the terminal device for display via the data communication port.
